(19) United States
(12) Patent Application Publication
(10) Pub. No.: US 2021/0306413 A1
(43) Pub. Date: Sep. 30, 2021

(54) Performance Enhanced CDN Service

(71) Applicant: Medianova Internet Hizmetleri Ve Ticaret Anonim Sirketi, Sisli/Istanbul (TR)

(72) Inventor: Serkan SEVIM, Istanbul (TR)

(73) Assignee: Medianova Internet Hizmetleri Ve Ticaret Anonim Sirketi, Sisli/Istanbul (TR)

(21) Appl. No.: 17/268,092

(22) PCT Filed: Sep. 13, 2019
(86) PCT No.: PCT/TR2019/050751

§ 371 Date: Feb. 12, 2021

(30) Foreign Application Priority Data
Jun. 26, 2019 (TR) 2019/09549

(51) Int. Cl. H04L 29/08; H04L 12/26

(52) U.S. Cl. CPC H04L 67/1091; H04L 43/0852; H04L 67/1029; H04L 67/2814

(57) ABSTRACT

Performance Enhanced CDN Service A Network Management System that establishes an overlay network on ISPs characterized in that; it contains following process steps, —Receiving a request from the end user (1001), —Checking whether the content is available on the Edge server (1002), —Freezing the response if it is available on the Edge server (1003), —If it is not available on the Edge server, asking to Origin-Shield (8), —Checking the availability of content by Origin-Shield (8) (1005), —If the Content is available in Origin-Shield (8), sending the content to the Edge server (1006), —The content being cached by the Edge server (1007), —If the content is not available in Origin-Shield (8), the determining the best route by the helper module (NOS Helper Module) (7) (1008), —Obtaining the best route for that content from that route store (11) in the helper module (7) (1009), —Providing the fastest route from the helper module (7) (1010), —Checking the fastest route obtained (1011), —If the fastest route is through another Origin-Shield (8), requesting that content from the Origin-Shield (8) server (1012), —If the fastest route is directly on the Origin-Shield (8) server, requesting that content from the Origin server (1013), —Checking the availability of content by Origin-Shield (8) (1014), —If the Content is available in Origin-Shield (8), sending the content to the requesting Origin-Shield (8) (1015), —If the Content is not available in Origin-Shield (8), requesting that content from the Origin server (1016), —Sending the content by the origin server to the requesting server (1017), —Cashing the content also by the Origin-Shield (8), which transmits content on request. —The caching of the content (writing to the server's memory) (1019).

### TECHNICAL FIELD

The invention relates to a Network Management System that establishes an overlay network on ISPs and additionally manages the Overlay network.

### PRIOR ART

Content Distribution Networks (CDN) allows content producers (Origin) to deliver pictures, video, and etc. content to users in different parts of the world swiftly. Such CDNs optimize the Origin side to provide a high performance content service.

Contents are cached at strategic points around the world. Even if content is cached, content service performance decreases. Said decrease is due to the fact that the network between Origin and CDN is managed by more than one Internet Service Provider (ISP). ISPs dynamically establish connections between each other and route them. Said connections and routings are carried out considering the parameters such as price, number of users and competition. It is not done with the shortest path in mind. Therefore, the way through which the content reaches to CDN platform from the Origin changes frequently and is not always the shortest. Therefore, CDNs do not always adhere to the time promised to customers.

There is little work in the prior art on the Network Management System that establishes an overlay network on ISPs and additionally manages the Overlay network. Ahmed et al. focus on the area between the final users and CDN serves in their study namely “Optimizing Internet transit routing for content delivery networks” Here, CDN embeds a JavaScript code into the web pages it serves to the users. Said code makes requests to CDN servers through different paths. Thus, it is understood through which ISP the CDN servers can reach the user as soon as possible. Optimum route is found for the users depending on the ISP fees and delays.

Medagliani et al. focus on a customized CDN architecture for video in their study namely “Overlay routing for fast video transfers in CDN”. In this study, the most appropriate way is chosen according to many performance parameters due to changes made by ISPs. No information is given about where the proposed system will work in the CDN architecture, how it will take place and how much it costs.

### Purpose of the Invention

The purpose of the invention is to isolate the performance of content services as much as possible from the changes made by ISPs.

Another purpose of the invention is to achieve a faster performance by directing content from Origin to the CDN platform through the shortest path available on the Overlay network.

Another purpose of the invention is to provide a CDN service with enhanced performance by making it more stable.

The system developed in order to realize the mentioned objectives is composed of the NOS Engine, Measurements Store, Communication Module, Routes Store, Origin Shield Overlay Network, Central Module, Helper Module, Origin Shield, ISP Network, Measurement Module, Routes Store and Communication Module.

### DESCRIPTION OF FIGURES

Attached FIG. 1 is the schematic view of the flow chart of the system.

FIG. 2 is a detailed schematic view of the system.

FIG. 3 is a detailed schematic view of the central module.

FIG. 4 is a schematic view of the flowchart of the algorithm running in The Nos Engine (1).

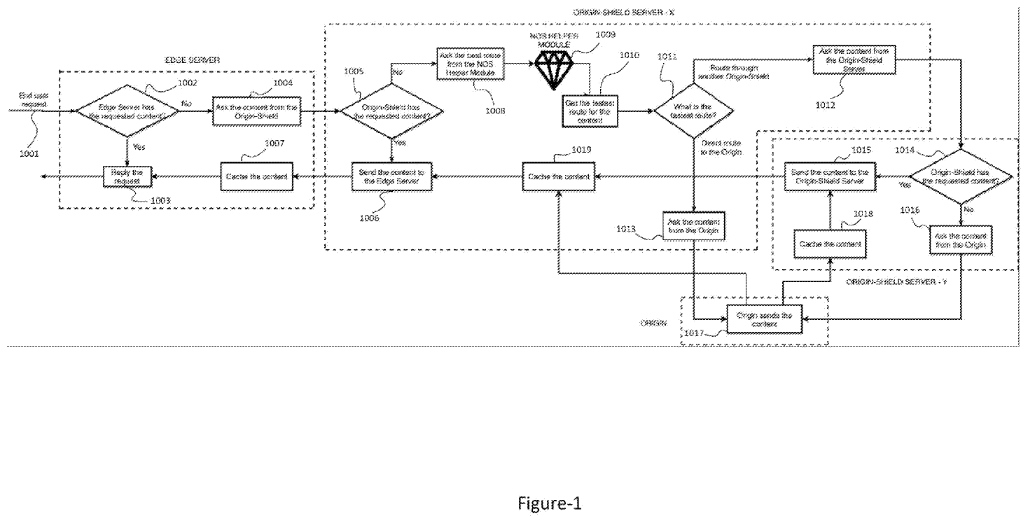

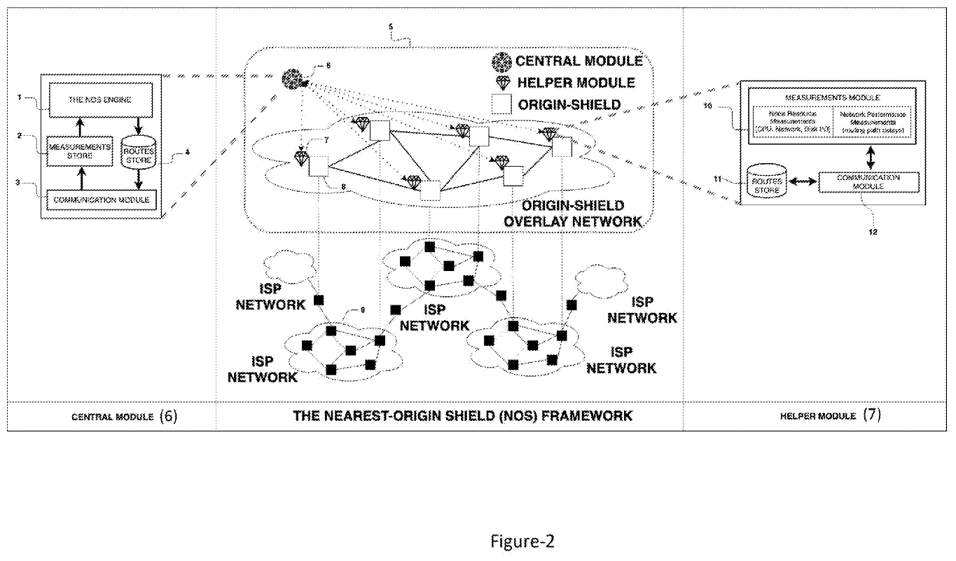

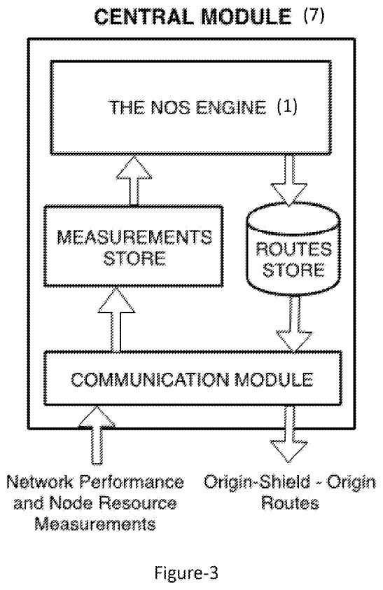

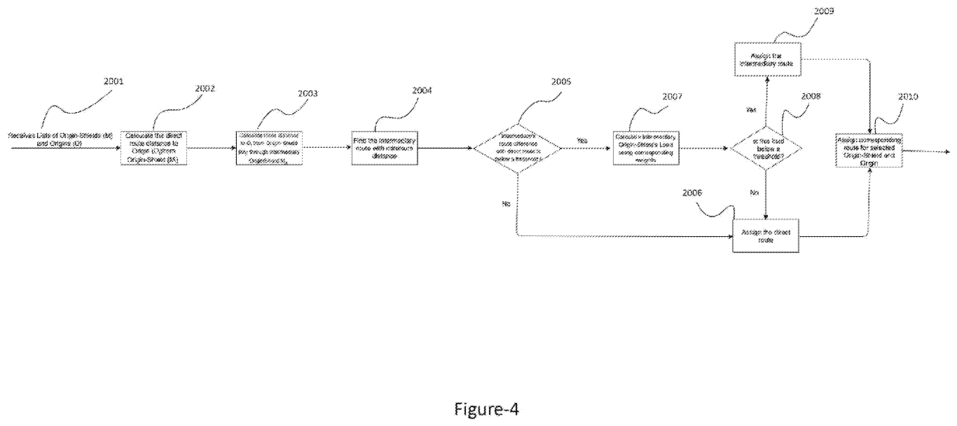

Numbers and names of main parts mentioned in the figures are given below.
(1) The NOS Engine
(2) Measurements Store
(3) Communication Module
(4) Routes Store
(5) Origin Shield Overlay Network
(6) Central Module
(7) Helper Module
(8) Origin Shield
(9) ISP Network
(10) Measurements Module
(11) Routes Store
(12) Communication Module

### DETAILED EXPLANATION OF THE INVENTION

The invention establishes an overlay network of servers (Origin-Shield) to be established on physical ISP networks. A network management system is being developed to manage the overlay based on changes in the underlying physical network.

The network management system consists of the central module (6) and the helper module (7). The helper module (7) runs on all origin-shield (8) servers. It is composed of a build-in measurement module (10), the route store (11) and the communication modules (12). The measurement module (10) measures the distance of the server on which it is located, to Origins and other servers in Overlay, as latency. It also measures the load status (CPU, disk, memory, network traffic) of the server hosting it.

The communication module (12) has two tasks: First; transmitting the measured latency and load values to the central module (6) and taking the routes determined by the central module (6). The second task is to exchange content with the content transfer protocol. Route store (11) accommodates the routes determined by the central module (6) of the Origins served by CDN serves. With the invention, the helper modules (7) take measurements periodically. It sends the measurements taken to the central module (6).

The central module (6) is composed of the communication module (3), the measurement store (2), the route store (4) and the NOS Engine (1). The communication module (3) receives latency and load measurements from the servers on the overlay network and transmits them to the measurement store (2). It also sends the routes from which the servers in the overlay network access the origin from the route store (4) to the corresponding server. The latency and load measurements are stored in the measurement store (2). It is preprocessed here and forwarded to the network operating module. The NOS Engine (1) determines the optimal route of each server in the overlay network to the origins by using an algorithm. The algorithm uses the load status of the servers in the overlay network, their distance between them and their distance to the origin. The routes specified by the NOS Engine (1) are written to the route store (4) and then distributed to all servers in the overlay.

The algorithm in the Nos Engine (1), which is located in the Central Module (6), has a decision mechanism and performs all calculations, comprises the following process steps;
Submission of the list of all Origin and Origin-Shield (8) servers from auxiliary modules to Central module (6) (2001),
Calculation of the Mj Oi distance (in latency) for each Origin (Oi) ye Origin-Shield (Mj) (8) server pair,
Calculation of the latency of the route from Origin-Shield (Mj) (8) to Origin (Oi) and passing through another intermediate Origin-Shield (8) (Mx, xi) (2003),
Selecting the route with the minimum latency between routes (Mi to Oi′) passing through the intermediary Origin-Shield (8) (2004),
Calculation of the latency difference between the route passing through the intermediary Origin-Shield (8) and the one going directly from Origin-Shield (8) to Origin (2005),
Selecting a route from Origin-Shield (8) (Mj) directly to Origin (Oi) if not below a threshold (2006)
If it is below a threshold: calculation of the total load of the intermediary Origin-Shield (8) by multiplying the load values with predetermined loads (CPU, Disk, etc.) by respective weights (2007)
Checking whether this total load value is below a threshold (2008),
If it's not below that threshold: Selecting the route from Origin-Shield (8) (Mj) directly to Origin (Oi) (2006),
If the calculated total load is below this threshold, selecting the route via this intermediary Origin-Shield (8) (2009),
Saving the route chosen for Origin-Shield (8)-Origin pair selected in step (2001).

Since it is not possible to control the physical networks managed by ISPs, an overlay network is established on the ISPs with the invention. In addition, a Network Management System has been developed to manage the Overlay network. This system quickly recognizes changes made by ISPs. With the system under the invention, it is decided through which route the Content will go from the Origin server to the platform. For this, the load of the servers (CPU and network traffic load, memory and disk fullness) and their distance to Origin are examined According to the information obtained, the routes are determined dynamically in the overlay network. This makes the performance of our CDN service more stable.

The NOS Engine (1) is the decision mechanism and the place where all calculations are made. The measurement store (2) is the place where all measurements from the helper module (7) are recorded. The communication module (3) is the mechanism that ensures communication and data flow between the helper module (7) and the central module (7). The route store (4) is the location where the routes belonging to all Origin-Shields (8) calculated by the central module 7 are stored. Origin Shield Overlay Network (5) is an Overlay Network built on a network of ISPs where the routing is performed unaffected by the underlying ISPs. The Central Module (6) is the location where all calculations are performed. The Helper Module (7) operates on all Origin-Shields (8). In addition it collects data such as latency, disk and so on and sends it to the central module (6). Origin Shield (8) is a type server with CDN Architecture and protects Origin servers from overloading. ISP Network (9) means ISPs composed of different Autonomous Systems. The Measurement Module (10) is located on each Origin-Shield (8). The route store (4) is the location where the route data of Origin Shield (8) running on it is stored. The communication module (12) is the mechanism that ensures communication and data flow between the helper module (7) and the central module (6).

The performance of services in content delivery networks needs to be isolated as much as possible from changes made by ISPs. Said isolation process can be provided by ensuring that the contents always come from the origins to the servers via the shortest route. With the invention, an overlay network of components is established on networks controlled by ISPs. In addition, a Network Management System is established to manage the overlay network according to the changes made by ISPs in the following networks.

The system offered by the invention listens the changes in the underlying network. Accordingly, it determines the shortest routes to the Origin in the overlay network. The latency of the route between the servers and the Origins are considered to determine the shortest route.

ISPs operate at Layer 3 and cannot be controlled. The CDN service is located at Layer 7. The invention solved the problems of Layer 3 which could not be controlled and reduce performance by establishing an overlay network in higher layers. The solution not only focuses on latency. In addition to latency times, server densities are also contemplated. In order to avoid overloading the servers in the Overlay network, the processor and traffic density of the servers and the disk and memory occupancy are also calculated. The network management system determines the optimal routes based on latency and server densities.

The invention relates to a Network Management System that establishes an overlay network on ISPs and it is composed of following steps:
Receiving a request from the end user (1001),
Checking whether the content is available on the Edge server (1002),
Freezing the response if it is available on the Edge server (1003),
If it is not available on the Edge server, asking to Origin-Shield (8),
Checking the availability of content by Origin-Shield (8) (1005),
If the Content is available in Origin-Shield (8), sending the content to the Edge server (1006),
The content being cached by the Edge server (1007),
If the content is not available in Origin-Shield (8), the determining the best route by the support module (NOS Helper Module) (7) (1008),
Obtaining the best route for that content from that route store (11) in the helper module (7) (1009),
Providing the fastest route from the helper module (10) (1010),
Checking the fastest route obtained (1011),
If the fastest route is through another Origin-Shield (8), requesting that content from the Origin-Shield (8) server (1012),
If the fastest route is directly on the Origin-Shield (8) server, requesting that content from the Origin server (1013),
Checking the availability of content by Origin-Shield (8) (1014),
If the Content is available in Origin-Shield (8), sending the content to the requesting Origin-Shield (8) (1015),
If the Content is not available in Origin-Shield (8), requesting that content from the Origin server (1016),
Sending the content by the origin server to the requesting server (1017),
Cashing the content also by the Origin-Shield (8), which transmits content on request.
The caching of the content (writing to the server's memory) (1019).

The codes for the mechanism for determining the best route for each Origin-Shield (8)-Origin-Pair (Pseudocode) are shown in the algorithm in table-1.

TABLE 1
Pseudocode of the Algorithm of the Invention

Require: List of Origin-Shields (M), list of Origins (O),

Helper Module measurements of routing path delays and
node loads,

| Ensure: Routes for each < Mᵢ, Oⱼ > | |
|---|---|
| 1: | for all < Mᵢ, Oⱼ > do |

| | |
|---|---|
| 2: | Calculate PathDelay(Mᵢ−Oⱼ) |
| 3: | for all Mₓ, x ≠ i do |

| | | |
|---|---|---|
| 4: | Calculate PathDelay(Mᵢ−Mₓ−Oⱼ) | = |

PathDelay(Mᵢ−Mₓ) + PathDelay(Mₓ−Oⱼ)

| | |
|---|---|
| 5: | end for |
| 6: | FAP = min(PathDelay(Mᵢ−Mₓ−Oⱼ)) |
| 7: | if (PathDelay(Mᵢ−Oⱼ) − FAP) ≥ TH_{Delay} then |

| | |
|---|---|
| 8: | Calculate Load_{M}_{ₓ} = α × CPU_{M}_{ₓ} + β × |

Network_{M}_{ₓ} + γ × Disk_{M}_{ₓ}

| | |
|---|---|
| 9: | if Load_{M}_{ₓ} ≤ TH_{Load} then |

| | |
|---|---|
| 10: | assign Route < Mᵢ, Oⱼ > = Mₓ |

| | |
|---|---|
| 11: | else |

| | |
|---|---|
| 12: | assign Route < Mᵢ, Oⱼ > = Oⱼ |

| | |
|---|---|
| 13: | end if |

TABLE 2
Parameters and Definitions

| Parameter | Definition |
|---|---|
| M = {M₁, . . . , Mₙ} | List of Origin-Shields |
| O = {O₁, . . . , Oₖ} | List of Origins |
| <Mᵢ, Oⱼ> | Origin-Shield i and Origin j pair |
| D(Mᵢ-Oⱼ) | End-to-end routing path delay between |
| | Origin-Shield i and Origin j |
| L_{M}_{ᵢ} | Calculated load for Origin-Shield i |
| α, β, γ | CPU, network, disk I/O weights |
| T | Threshold |
| D_{ARP} | Fastest Alternate Path delay |
| U_{M}_{ₓ}^{C}, U_{M}_{ₓ}^{D}, U_{M}_{ₓ}^{N} | CPU, disk I/O, network usage(%) of |
| | Origin-Shield x |

1. A Network Management System that establishes an overlay network on ISPs comprising following process steps,
receiving a request from an end user,
checking whether a content is available on an Edge server,
freezing a response if it is available on the Edge server,
if it is not available on the Edge server, asking for an Origin-Shield,
checking, the availability of content by the Origin-Shield,
if the content is available in the Origin-Shield, sending the content to the Edge server,
the content being cached by the Edge server,
if the content is not available in the Origin-Shield, determining the best route by a helper module (NOS Helper Module),
obtaining the best route for that content from that route store in the helper module,
providing the fastest route from the helper module,
checking the fastest route obtained,
If the fastest route is through another Origin-Shield, requesting that content from the Origin-Shield server,
if the fastest route is directly on the Origin-Shield server, requesting that content from the Origin server,
checking the availability of the content by the Origin-Shield,
if the content is available in the Origin-Shield, sending the content to the requesting Origin-Shield,
if the content is not available in the Origin-Shield, requesting that content from the Origin server,
sending the content by the origin server to the requesting server,
cashing the content also by the Origin-Shield, which transmits the content on request, and
caching of the content (writing to the server's memory).

2. A Network Management System that establishes an overlay network on ISPs comprising following process steps,
a NOS engine, which is a decision mechanism and performs all calculations,
an Origin Shield Overlay Network, which is an Overlay Network built on a network of ISPs where the routing is performed unaffected by the underlying ISPs,
a central module that performs all calculations,
a helper module that runs on all Origin-Shields, collects data such as latency, disc and sends them to the central module.

3. An algorithm running in the Nos Engine of claim 2 comprising following process steps,
submission of a list of all Origin and Origin-Shield servers from auxiliary modules to a central module,
calculation of the Mj Oi distance (in latency) for each Origin (Oi) ve Origin-Shield (Mj) server pair,
calculation of the latency of the route from Origin-Shield (Mj) to Origin (Oi) and passing through another intermediate Origin-Shield (Mx, xi),
selecting the route with the minimum latency between routes (Mi to Oi) passing through the intermediary Origin-Shield,
calculation of the latency difference between the route passing through the intermediary Origin-Shield and the one going directly from Origin-Shield to Origin,
selecting a route from Origin-Shield (Mj) directly to Origin (Oi) if not below a threshold,
if it is below a threshold: calculation of the total load of the intermediary Origin-Shield by multiplying the load values with predetermined loads (CPU, Disk, etc.) by respective weights,
checking whether this total load value is below a threshold,
if the total load is not below that threshold: selecting the route from Origin-Shield (Mj) directly to Origin (Oi),
if the calculated total load is below this threshold, selecting the route via this intermediary Origin-Shield, and
saving the route chosen for Origin-Shield Origin pair selected.

4. The system of claim 2, wherein the system comprises a measuring store in which all measurements from the helper module are recorded.

5. The system of claim 2, wherein the system comprises a communication module that ensures communication and data flow between the helper module and the central module.

6. The system of claim 2, wherein the system comprises a route store where the routes belonging to all Origin-Shields calculated by the central module are stored.

7. The system of claim 2, wherein the system is a type of server with CDN Architecture and it comprises the Origin Shield which protects Origin servers from overloading.

8. The system of claim 2, wherein the system comprises an ISP Network of ISPs composed of different Autonomous Systems.

9. The system of claim 2, wherein the s stem comprises a measurement module on each Origin-Shield, which measures the distance of the server on which it is located, to Origins and other servers in Overlay, in latency, but also measures the load status (CPU, disk, memory, network traffic) of the server it is on.
